(19) United States
(12) Patent Application Publication
(10) Pub. No.: US 2023/0299827 A1
(43) Pub. Date: Sep. 21, 2023

(54) CSI REPORTING CONFIGURATION

(71) Applicant: NEC Corporation, Minato-ku, Tokyo (JP)

(72) Inventor: Ayesha IJAZ, Guildford (GB)

(73) Assignee: NEC Corporation, Minato-ku, Tokyo (JP)

(21) Appl. No.: 17/626,211

(22) PCT Filed: Jul. 30, 2021
(86) PCT No.: PCT/JP2021/028457

§ 371 Date: Jan. 11, 2022

(30) Foreign Application Priority Data
Aug. 7, 2020 (GB) 2012333.7

(51) Int. Cl. H04B 7/06; H04W 72/23; H04W 72/1268; H04L 1/1812

(52) U.S. Cl. CPC H04B 7/0626; H04L 1/1812; H04W 72/1268; H04W 72/23

(57) ABSTRACT

A communication system is disclosed in which an access network node determines a CSI feedback occasion in respect of a terminal device, determines if a PUSCH data transmission can be scheduled earlier than a PUCCH data transmission or if a PDSCH data transmission is to be scheduled; and if a PUSCH data transmission cannot be scheduled earlier than a PUCCH data transmission or a PDSCH data transmission is to be scheduled, transmits a downlink DCI of Downlink DCI format to the terminal device, the downlink DCI being configured to trigger generation by the terminal device of CSI reporting data; wherein the downlink DCI is further configured to schedule either a PUSCH or a PUCCH data transmission to support transmission of the CSI reporting data, depending on PUCCH availability when the CSI feedback occasion is determined.

### TECHNICAL FIELD

The present invention relates to a wireless communication system and devices thereof operating according to the 3rd Generation Partnership Project (3GPP) standards or equivalents or derivatives thereof. The disclosure has particular but not exclusive relevance to improvements relating to Ultra-Reliable and Low-Latency Communications in the so-called ‘5G’ (or ‘Next Generation’) systems.

### BACKGROUND ART

The latest developments of the 3GPP standards are the so-called ‘5G’ or ‘New Radio’ (NR) standards which refer to an evolving communication technology that is expected to support a variety of applications and services such as Machine Type Communications (MTC), Internet of Things (IoT) communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

End-user communication devices are commonly referred to as User Equipment (UE) which may be operated by a human or comprise automated (MTC/IoT) devices. Whilst a base station of a 5G/NR communication system is commonly referred to as a New Radio Base Station (′NR-BS′) or as a ′gNB′ it will be appreciated that they may be referred to using the term ′eNB′ (or 5G/NR eNB) which is more typically associated with Long Term Evolution (LTE) base stations (also commonly referred to as ′4G′ base stations). 3GPP Technical Specification (TS) 38.300 V16.2.0 and 3GPP TS 37.340 V16.2.0 define the following nodes, amongst others:
gNB: node providing NR user plane and control plane protocol terminations towards the UE, and connected via the NG interface to the 5G core network (5GC).
ng-eNB: node providing Evolved Universal Terrestrial Radio Access (E-UTRA) user plane and control plane protocol terminations towards the UE, and connected via the NG interface to the 5GC.
En-gNB: node providing NR user plane and control plane protocol terminations towards the UE, and acting as Secondary Node in E-UTRA-NR Dual Connectivity (EN-DC).
NG-RAN node: either a gNB or an ng-eNB.

3GPP also defined the so-called ‘Xn’ interface as the network interface between neighbouring NG-RAN nodes.

The next-generation mobile networks support diversified service requirements, which have been classified into three categories by the International Telecommunication Union (ITU): Enhanced Mobile Broadband (eMBB); Ultra-Reliable and Low-Latency Communications (URLLC); and Massive Machine Type Communications (mMTC). eMBB aims to provide enhanced support of conventional mobile broadband, with focus on services requiring large and guaranteed bandwidth such as High Definition (HD) video, Virtual Reality (VR), and Augmented Reality (AR). URLLC is a requirement for critical applications such as automated driving and factory automation, which require guaranteed access within a very short time. MMTC needs to support massive number of connected devices such as smart metering and environment monitoring but can usually tolerate certain access delay. It will be appreciated that some of these applications may have relatively lenient Quality of Service/Quality of Experience (QoS/QoE) requirements, while some applications may have relatively stringent QoS/QoE requirements (e.g., high bandwidth and/or low latency).

The Physical Uplink Control Channel (PUCCH) carries a set of information called Uplink Control Information (UCI). The format of the PUCCH depends on what kind of information the UCI carries. The PUCCH format to be used is determined by how many bits of information should be carried and how many symbols are assigned. The UCI used in NR (5G) includes one or more of the following information: Channel State Information (CSI); ACK/NAK; and Scheduling Request (SR). This is generally the same as in LTE (4G), as will be described in more detail hereinafter.

The Physical Downlink Control Channel (PDCCH) carries a set of information called Downlink Control Information (DCI). The DCI used in NR (5G) includes information indicating resource assignment in uplink (UL) or downlink (DL), for a single Radio Network Temporary Identifier (RNTI), e.g., a UE, depending on its Format. There are various DCI formats used in LTE and NR (5G), each of which is a predefined format in which the downlink control information is packed/formed and transmitted in PDCCH. The DCI is used to schedule transmissions from the gNB to the UE (downlink) and from the UE to the gNB (uplink) and provide such scheduling information to the UE. Accordingly, DCIs are further classified into downlink DCI formats and uplink DCI formats. DCI Formats and their contents are set forth in 3GPP TS 38.212 V16.2.0, 3GPP TS 38.213 V16.2.0, 3GPP TS 38.214 V16.2.0, and 3GPP TS 38.331 V16.1.0. For example, Format 0_0 is used to schedule Physical Uplink Shared Channel (PUSCH) data transmissions in one cell (Uplink (UL) grant) and Format 1_0 is used to schedule a Physical Downlink Shared Channel (PDSCH) data transmission in one cell (Downlink (DL) grant.

In communications, the UE is configured to estimate and report the CSI of a communication channel between it and the gNB, and this CSI is used in a CSI feedback framework for, amongst other things, enabling appropriate Modulation and Coding Scheme (MCS) selection by the gNB based on the channel conditions over all or part of the bandwidth. The MCS defines the number of useful bits that can be carried by one symbol or, more accurately in relation to NR (5G), how many useful bits can be transmitted per Resource Element (RE). MCS depends on radio signal quality in a wireless link, wherein the better the quality of the link, the higher will be the MCS and the more useful bits that can be transmitted within a symbol or RE. The allocated MCS is signalled to the UE using a DCI over the PDCCH, and defines a modulation and code rate, and three different MCS tables are defined in 3GPP TS 38.214 5G NR Physical Layer procedures for data.

Generally, LTE utilises an implicit rank indicator (RI)/Precoding Matrix Indicator (PMI)/Channel Quality Indicator (CQI) feedback framework for the CSI feedback. Together, a combination of the RI, PMI, and CQI forms a channel-state report, and the CSI feedback framework is “implicit” in the form of CQI/PMI/RI (and Channel Rank Indicator (CRI) in the LTE specification) derived from a codebook. Rank Indicator (RI) is information relating to a channel rank and indicates the number of streams/ layers that can be received via the same time-frequency resource. Since RI is determined by long term fading of a channel, it may be generally fed back at a cycle longer than that of PMI or CQI. PMI Is a value indicating a spatial characteristic of a channel and indicates a precoding matrix index of the network device (gNB) preferred by the respective terminal device (UE). CQI is information indicating the strength of a channel and a reception Signal-to-Interference-plus-Noise Ratio (SINR) when the gNB uses PMI.

In Release Rel-17 on enhanced Industrial Internet of Things (IIOT) and URLLC support (see RP-201310, “Revised WID: Enhanced Industrial Internet of Things (IIoT) and ultra-reliable low latency communication (URLLC) support for NR”, TSG-RAN#88e, June 22 - Jul. 03, 2020), one of the objectives is to study, identify and specify if required, CSI feedback enhancements to allow for more accurate MCS selection. CSI feedback enhancement to improve link adaptation is beneficial for URLLC reliability. The estimated CSI should be reliable and delivered in a timely and reliable manner to the gNB to improve latency and reliability, particularly in URLLC. In Rel-16, the CSI reporting configuration for CSI can be periodic (P-CSI) using PUCCH, aperiodic (A-CSI) using PUSCH, or semi-persistent (SP-CSI) using PUCCH and DCI-activated PUSCH. In periodic CSI reporting, the reporting time periods (i.e., the time periods defining the reporting points) are determined at a higher layer, using the RRC message and, at the appropriate junctures, CSI data is transmitted, by the UE to the gNB, using PUCCH; whereas, in aperiodic reporting, CSI feedback is triggered as required by the gNB, using DCI (Format 1) over the PDCCH. In this case, the CSI data is transmitted to the UE over the PUSCH. A-CSI may form the principal CSI feedback framework of a communication system, or it may be a supplementary configuration, and triggered, for example, to deal with a failed detection of P-CSI or SP-CSI reporting. As described above, in A-CSI reporting, a CSI report from a UE is triggered by DCI (Format 1, over PDCCH), which acts to schedule a PUSCH transmission from the UE. The UE then transmits the CSI data using PUSCH. If there is no other ULSCH data to be transmitted at that time, the CSI reporting process uses additional resources (that would not otherwise be used for normal data transmissions between the UE and the gNB). Not only is there an additional scheduled ULSCH data transmission for each A-CSI request, but by only using an uplink DCI format, there is an additional scheduled PDCCH data transmission for each A-CSI request. Thus, an especially in DL-heavy traffic systems, there is an adverse effect on resource efficiency and control overhead. Furthermore, in a case where the system is configured such that a CSI report is only transmitted when other ULSCH data is transmitted (to improve resource efficiency), there may be a significant adverse impact on CSI feedback latency, as there may be a time delay between receipt, by the UE, of the DCI trigger and the next scheduled ULSCH data transmission.

There is a desire to improve the speed and resolution of CSI feedback for URLLC in particular, and to avoid large scheduling latency, particularly in DL-centric TDD systems, for example, and, more generally, to provide timely and accurate CSI feedback.

In Rel-16 on URLLC, it was observed that A-CSI reporting is more (resource) efficient than P-CSI for URLLC. However, and as described above, especially in a DL-heavy application, triggering A-CSI reporting by downlink DCI is not resource efficient and can lead to an increased CSI feedback latency. Furthermore, the control overhead is increased using this type of CSI feedback framework.

### SUMMARY OF INVENTION

Accordingly, the present invention seeks to provide methods and associated apparatus that address or at least alleviate (at least some of) the above described issues.

Although for efficiency of understanding for those of skill in the art, the invention will be described in detail in the context of a 3GPP system (5G networks), the principles of the invention can be applied to other systems as well.

The present invention provides a method performed an access network node of a communications system comprising at least one terminal device being communicably linked to the access network node via a communications link comprising a PDCCH, a PDSCH, a PUCCH and a PUSCH, the method comprising, for a CSI feedback occasion in respect of the terminal device: if a PUSCH data transmission cannot be scheduled earlier than a PUCCH data transmission or a PDSCH data transmission is to be scheduled, transmitting a downlink DCI of Downlink DCI format to said terminal device, said downlink DCI being configured to trigger generation by the terminal device of CSI reporting data; wherein said downlink DCI is further configured to schedule either a PUSCH or a PUCCH data transmission to support transmission of said CSI reporting data, depending on PUCCH availability when said CSI feedback occasion is determined.

The present invention also provides an access network node of a communication system, the access network node being configured to be communicably coupled to a terminal device via a communications link comprising a PDCCH, a PDSCH, a PUCCH and a PUSCH, and comprising: means for triggering a CSI feedback occasion in respect of a terminal device and configured to, if a PUSCH data transmission cannot be scheduled earlier than a PUCCH data transmission or a PDSCH data transmission is to be scheduled, transmit a downlink DCI of Downlink DCI format to said terminal device, said downlink DCI being configured to trigger generation by the terminal device of CSI reporting data; wherein said downlink DCI is further configured to schedule either a PUSCH or a PUCCH data transmission to support transmission of said CSI reporting data, depending on PUCCH availability when said CSI feedback occasion is determined.

The present invention provides a method performed by a terminal device communicably coupled to an access network node of a communications system via a communications link comprising a PDCCH, a PDSCH, a PUCCH and PUSCH, the method comprising: receiving a downlink DCI of downlink DCI format, said downlink DCI being configured to trigger generation by the terminal device of CSI reporting data; wherein said downlink DCI is further configured to schedule either a PUSCH or a PUCCH data transmission to support transmission of said CSI reporting data; and transmitting CSI reporting data to said access network node by means of a PUCCH or PUSCH data transmission, depending on a respective resource allocation in said received downlink DCI.

The present invention provides a terminal device of a communications system comprising at least one access network node to which said terminal device can be communicably coupled via a communications link comprising a PDCCH, a PDSCH, a PUCCH and a PUSCH, the terminal device comprising: means for receiving a downlink DCI of downlink DCI format, said downlink DCI being configured to trigger generation by the terminal device of CSI reporting data; wherein said downlink DCI is further configured to schedule either a PUSCH or a PUCCH data transmission to support transmission of said CSI reporting data; and means for transmitting CSI reporting data to said access network node by means of a PUCCH or PUSCH data transmission, depending on a respective resource allocation in said received downlink DCI.

Example aspects of the invention extend to corresponding systems, apparatus, and computer program products such as computer readable storage media having instructions stored thereon which are operable to program a programmable processor to carry out a method as described in the example aspects and possibilities set out above or recited in the claims and/or to program a suitably adapted computer to provide the apparatus recited in any of the claims.

The present invention is defined by the claims appended hereto. Example aspects of the invention are as set out in the independent claims. Some optional features are set out in the dependent claims.

However, each feature disclosed in this specification (which term includes the claims) and/or shown in the drawings may be incorporated in the invention independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Example embodiments of the invention will now be described, by way of example, with reference to the accompanying drawings in which:

FIG. 1 illustrates schematically a mobile (cellular or wireless) telecommunication system to which example embodiments of the invention may be applied;

FIG. 2 is a schematic block diagram of a mobile device forming part of the system shown in FIG. 1;

FIG. 3 is a schematic block diagram of an access network node (e.g., base station) forming part of the system shown in FIG. 1;

FIG. 4 is a schematic block diagram of a core network node forming part of the system shown in FIG. 1;

FIG. 5A is a schematic illustration of a format of an uplink grant DCI message;

FIG. 5B is a schematic illustration of a format of a downlink grant DCI message;

FIG. 6 is a schematic process flow diagram illustrating a method according to an example embodiment of the present invention;

FIG. 7A is a schematic illustration of a downlink DCI format used in an example embodiment of the invention; and

FIG. 7B is a schematic illustration of an alternative downlink DCI format used in an exemplary embodiment of the invention.

### DESCRIPTION OF EMBODIMENTS

### Overview

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect IoT devices and similar MTC devices to the network. For simplicity, the present application will use the term base station to refer to any such base stations and use the term mobile device or UE to refer to any such communication device.

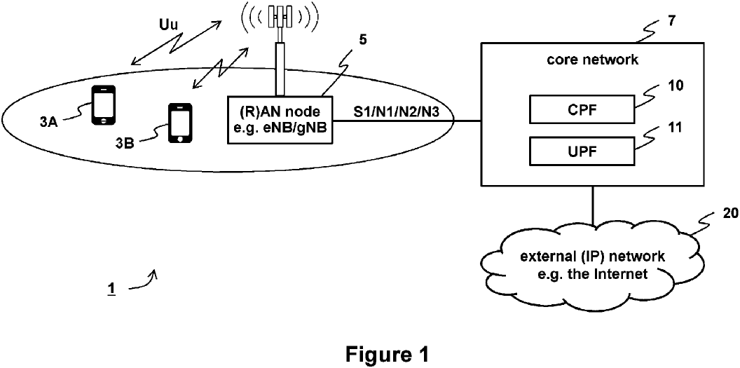

FIG. 1 illustrates schematically a mobile (cellular or wireless) telecommunication system 1 to which example embodiments of the invention may be applied.

In this system 1, users of mobile devices 3 (UEs) can communicate with each other and other users via respective base stations 5 and a core network 7 using an appropriate 3GPP radio access technology (RAT), for example, an E-UTRA and/or 5G RAT. It will be appreciated that a number of base stations 5 form a (radio) access network or (R)AN. As those skilled in the art will appreciate, whilst two mobile devices 3A and 3B and one base station 5 are shown in FIG. 1 for illustration purposes, the system, when implemented, will typically include other base stations and mobile devices (UEs).

Each base station 5 controls one or more associated cells (either directly or via other nodes such as home base stations, relays, remote radio heads, distributed units, and/or the like). A base station 5 that supports E-UTRA/4G protocols may be referred to as an ′eNB′ and a base station 5 that supports NextGeneration/5G protocols may be referred to as a ′gNBs′. It will be appreciated that some base stations 5 may be configured to support both 4G and 5G protocols, and/or any other 3GPP or non-3GPP communication protocols.

The mobile devices 3 and their serving base station 5 are connected via an appropriate air interface (for example the so-called ‘Uu’ interface and/or the like). Neighbouring base stations 5 are connected to each other via an appropriate base station to base station interface (such as the so-called ‘X2’ interface, ‘Xn’ interface and/or the like). The base station 5 is also connected to the core network nodes via an appropriate interface (such as the so-called ‘S1’, ‘N1’, ‘N2’, ‘N3’ interface, and/or the like).

The core network 7 (e.g., the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’ / 5G system will include user plane entities and control plane entities. In this example, the core network includes at least one control plane function (CPF) 10 and at least one user plane function (UPF) 11. It will be appreciated that the core network 7 may also include one or more of the following: an Access and Mobility Function (AMF), a Session Management Function (SMF), a Policy Control Function (PCF), an Application Function (AF), an Authentication Server Function (AUSF), a Unified Data Management (UDM) entity, amongst others. The core network 7 is also coupled (via the UPF 11) to a Data Network (DN) 20, such as the Internet or a similar Internet Protocol (IP) based network (denoted ‘external network’ in FIG. 1).

It will be appreciated that each mobile device 3 may support one or more services which may fall into one of the categories defined above (URLLC/eMBB/mMTC). Each service will typically have associated requirements (e.g., latency/data rate/packet loss requirements, etc.), which may be different for different services.

### User Equipment (UE)

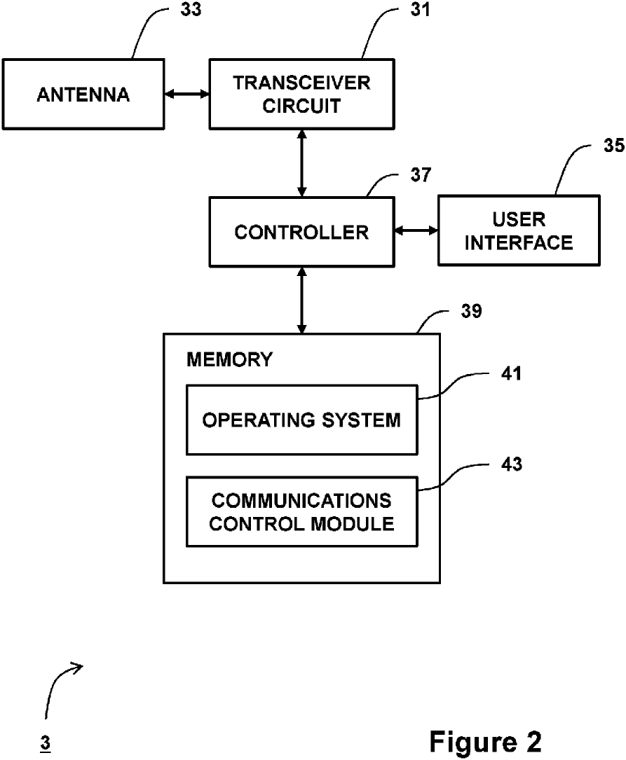

FIG. 2 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, and a communications control module 43.

The communications control module 43 is responsible for handling (generating/sending/ receiving) signalling messages and uplink/downlink data packets between the UE 3 and other nodes, including (R)AN nodes 5 and core network nodes. The signalling may comprise control signalling (including UCI and DCI) related to the PUCCH and/or PDCCH (amongst others). The communications control module 43 is also responsible for determining the resource sets and codebooks to be used for a particular channel.

### Access Network Node (Base Station)

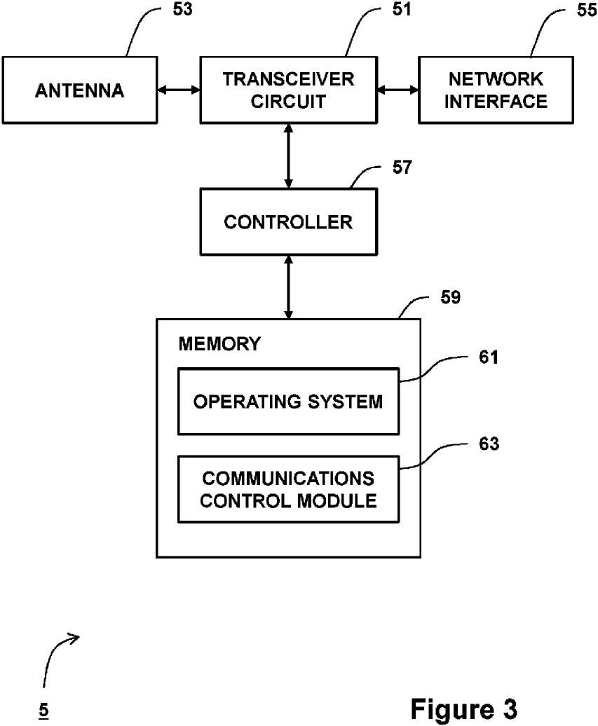

FIG. 3 is a block diagram illustrating the main components of the base station 5 (or a similar access network node) shown in FIG. 1. As shown, the base station 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station - base station interface (such as X2/Xn) and an appropriate base station - core network interface (such as S1/N1/N2/N3). A controller 57 controls the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, and a communications control module 63.

The communications control module 63 is responsible for handling (generating/sending/ receiving) signalling between the base station 5 and other nodes, such as the UE 3 and the core network nodes. The signalling may comprise control signalling (including UCI and DCI) related to the PUCCH and/or PDCCH (amongst others). The communications control module 63 is also responsible for determining the resource sets and codebooks for a particular channel.

### Core Network Function

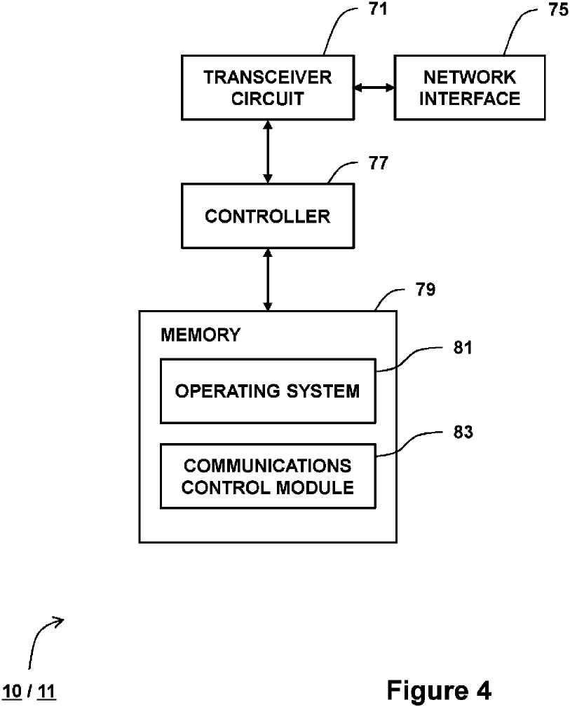

FIG. 4 is a block diagram illustrating the main components of a generic core network function, such as the UPF 11 or the AMF 12 shown in FIG. 1. As shown, the core network function includes a transceiver circuit 71 which is operable to transmit signals to and to receive signals from other nodes (including the UE 3, the base station 5, and other core network nodes) via a network interface 75. A controller 77 controls the operation of the core network function in accordance with software stored in a memory 79. The software may be pre-installed in the memory 79 and/or may be downloaded via the telecommunication network 1 or from a removable data storage device (RMD), for example. The software includes, among other things, an operating system 81, and a communications control module 83.

The communications control module 83 is responsible for handling (generating/sending/ receiving) signaling between the core network function and other nodes, such as the UE 3, the base station 5, and other core network nodes.

### Detailed Description

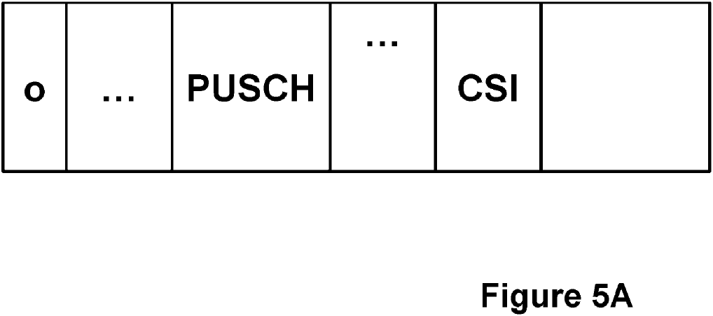

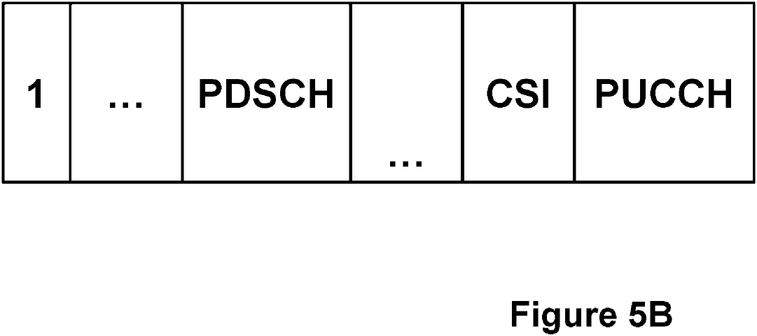

A more detailed description of some exemplary embodiments and features is provided below with reference to FIGS. 5A to 7B.

Referring to FIG. 5A of the drawings, an example format of a UL (uplink grant) DCI (e.g., Format 1_0) is illustrated schematically. As shown, the UL DCI message includes a number of fields, including a CSI request field and PUSCH resource assignment fields. These, and other fields represented in the illustrated DCI format, are referenced and discussed in, for example, 3GPP TS 38.212, 3GPP TS 38.213, 3GPP TS 38.214, and 3GPP TS 38.331, and will not be discussed in further detail herein. In a known CSI feedback framework using aperiodic an (A-CSI) feedback regime, if the CSI request field is populated in a UL DCI message, the UE generates CSI report data and transmits the CSI report data to the gNB using the PUSCH resources allocated in the DCI message. The CSI trigger frequency can be preconfigured at a higher level (e.g., by RRC message), but a CSI trigger can also be generated, in some systems, as a result of a failed P-CSI or SP-CSI process. The PUSCH resource allocation in uplink grant is flexible enough to accommodate CSI and, in particular, in non-slot based scheduling, it allows the flexibility to assign almost any number of OFDM symbols for PUSCH. However, as explained above, this form of aperiodic CSI feedback framework can result in an unnecessarily high control overhead in circumstances where no other PUSCH data transmission is scheduled, and PUSCH is only scheduled for CSI reporting. Also, fast CSI reporting may not be possible in DL-heavy data traffic conditions.

Referring to FIG. 5B of the drawings, an example format of a DL (downlink grant) DCI (e.g., Format 1_1) is illustrated schematically. As shown, the DL DCI message includes a number of fields, including PDSCH resource assignment fields, a CSI trigger field and PUCCH resource assignment fields. As set out in 3GPP TS 38.213, a UE provides HAR-ACK information in a PUCCH transmission in response to detecting a DL DCI message. Thus, the PUCCH resource indicator field serves to specify, to the UE, a PUCCH resource to be used to transmit a HARQ-ACK message in response to the DCI message. The CSI trigger field, when appropriately populated in a known CSI feedback framework, triggers the UE to generate CSI report data and transmit that report data, multiplexed with the required HARQ-ACK message data, using the allocated PUCCH resource. The CSI trigger field may be used for A-CSI if the system is so preconfigured. However, it may also be used as a back up to P-CSI or SP-CSI feedback frameworks. In DL-heavy traffic applications, using the PUCCH resource can allow fast CSI reporting, but there is a risk that there will be insufficient PUCCH resource available to multiplex the CSI report data and the HARQ-ACK message data without affecting the reliability and latency of the HARQ-ACK feedback.

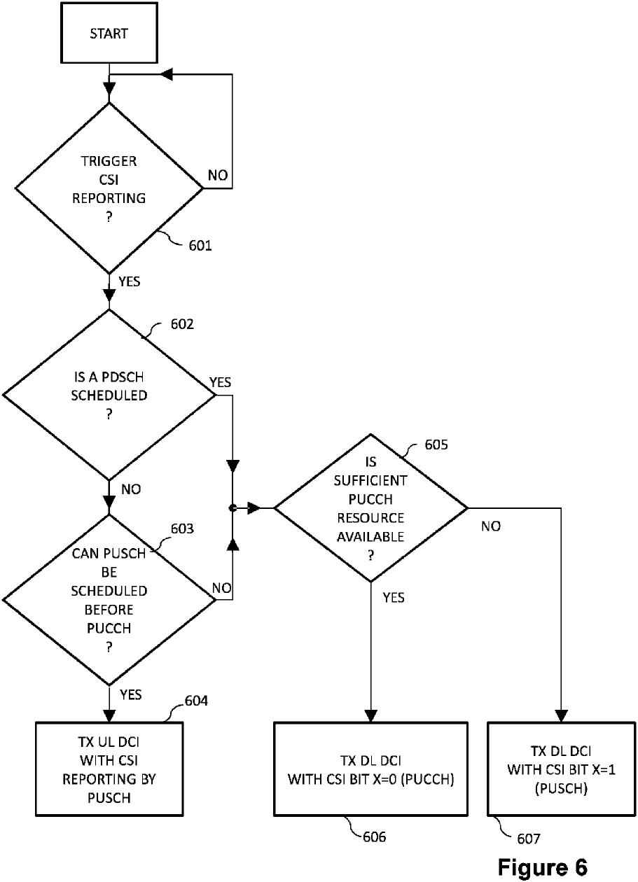

Referring to FIG. 6 of the drawings, in a method according to an exemplary embodiment of the present invention, performed by a network access node such as a gNB, an aperiodic CSI feedback process starts, at step 601, by determining if CSI reporting is required. If not, the gNB continues to operate as preconfigured until it determines that a CSI report should be triggered. This may be achieved in any known manner associated with aperiodic CSI reporting, and as will be apparent to a person skilled in the art.

When the gNB determines that a CSI report should be triggered, it determines, at step 602, if a PDSCH transmission is already scheduled for the respective UE. If so, it proceeds to step 605. If not, it determines, at step 603, if a PUSCH message can be scheduled earlier or more quickly than a PUCCH message. If not, it proceeds to step 605. If not, it generates and transmits (using PDCCH) an uplink DCI including a CSI request for reporting by allocated PUSCH resources, as would be the case in a known aperiodic CSI feedback framework. The DCI could, for example, have the format illustrated in FIG. 5A of the drawings.

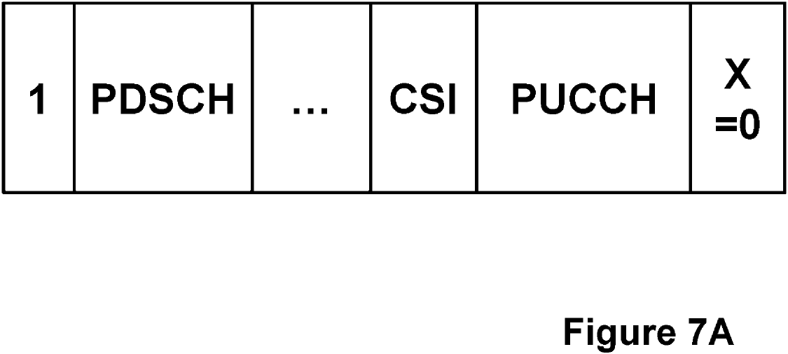

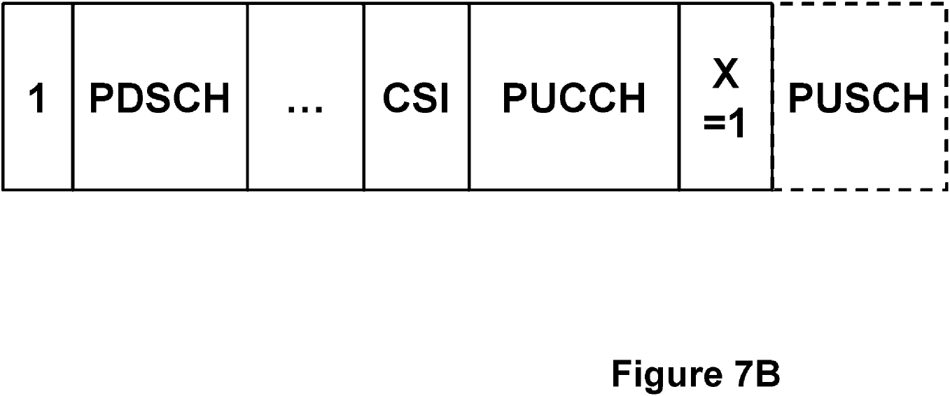

As described above, if a PDSCH data transmission is already scheduled for the respective UE when CSI reporting is required to be triggered (as determined at step 602 and/or if it is determined, at step 603, that a PUSCH message cannot be scheduled before a PUCCH message, the gNB proceeds to step 605. At step 605, it is determined whether or not there are sufficient PUCCH resources available for allocation in a DL DCI to be used to transmit multiplexed A-CSI report data and HARQ-ACK data without compromising the reliability or latency of HARQ-ACK feedback. If so, it proceeds to step 606 and generates and transmits a DL DCI with the CSI trigger field populated appropriately to trigger a CSI report. In this case, and as shown schematically in FIG. 7A, the DL DCI format has an additional bit x (which may be an existing bit, reused for the present purpose, or a newly-defined field) which can be set to, for example, ‘0’ to signify to the UE that CSI report data is required to be multiplexed with the HARQ-ACK message data and transmitted to the gNB using the allocated PUCCH resources.

However, if it is determined that multiplexing the CSI report data with the HARQ-ACK data and transmitting the multiplexed signal to the gNB via the allocated PUCCH resources would adversely impact the reliability and latency of the HARQ-ACK feedback, then the method proceeds to step 607, and the gNB generates and transmits (using PDCCH) a DL DCI in which the CSI trigger field is once again appropriately populated but, in this case, the bit x is set to ‘1’ which signifies to the UE to transmit the CSI report data using PUSCH transmission. The PUSCH resources allocated for this purpose could be preconfigured at a higher layer or the DCI could include a newly-defined field, as shown in FIG. 7B of the drawings, wherein PUSCH resources are allocated for transmitting the CSI report data.

As a result of the method described above, timely CSI feedback reporting can be achieved under all circumstances, and without having an adverse effect on the reliability and latency of the HARQ-ACK feedback. Unnecessary control overhead is mitigated because if a PDSCH message is scheduled at the time that a CSI report is to be triggered, then the gNB is configured to use a DL DCI message (which it would have sent anyway, to support the scheduled PDSCH data transmission), instead of an additional UL DCI. Any problems associated with PDCCH blocking can also be avoided, because unnecessary control overhead is mitigated. Furthermore, the method described above allows for flexibility in data transmission scheduling by the gNB. Indeed, the example embodiment described above combines a number of different CSI triggering and reporting options, using both UL and DL DCI messages and both PUSCH and PUCCH, as appropriate, with a view to enabling faster and more flexible A-CSI reporting without unnecessary increase in control overhead or adverse impact on HARQ-ACK feedback.

### Modifications and Alternatives

Detailed example embodiments have been described above. As those skilled in the art will appreciate, a number of modifications and alternatives can be made to the above example embodiments whilst still benefiting from the inventions embodied therein. By way of illustration only a number of these alternatives and modifications will now be described.

It will be appreciated that the above example embodiments may be applied to both 5G New Radio and LTE systems (E-UTRAN).

In the above description, the UE, the access network node (base station), and the core network node are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories / caches (program and/or data); processing registers; communication buses (e.g., control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE, the access network node (base station), and the core network node as a signal over a computer network, or on a recording medium. Further, the functionality performed by part or all of this software may be performed using one or more dedicated hardware circuits. However, the use of software modules is preferred as it facilitates the updating of the UE, the access network node, and the core network node in order to update their functionalities.

It will be appreciated that when control plane - user plane (CP-UP) split is employed, the base station may be split into separate control-plane and user-plane entities, each of which may include an associated transceiver circuit, antenna, network interface, controller, memory, operating system, and communications control module. When the base station comprises a distributed base station, the network interface (reference numeral 55 in FIG. 3) also includes an El interface and an F1 interface (F1-C for the control plane and F1-U for the user plane) to communicate signals between respective functions of the distributed base station. In this case, the communications control module is also responsible for communications (generating, sending, and receiving signalling messages) between the control-plane and user-plane parts of the base station. It will be appreciated that when a distributed base station is used there is no need to involve both the control-plane and user-plane parts for pre-emption of communication resources as described in the above exemplary embodiments. It will be appreciated that pre-emption may be handled by the user-plane part of the base station without involving the control-plane part (or vice versa).

The above example embodiments are also applicable to ‘non-mobile’ or generally stationary user equipment. The above described mobile device may comprise an MTC/ IoT device and/or the like.

The DCI may comprise a specific radio network temporary identifier (e.g., ‘MCS-C-RNTI’) for scheduling Ultra-Reliable and Low-Latency Communications (URLLC).

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/ or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IoT), using a variety of wired and/ or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g., vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: 3GPP TS 22.368 V13.1.0, Annex B, the contents of which are incorporated herein by reference). This list is not exhaustive and is intended to be indicative of some examples of machine type communication applications.

TABLE 1

| Service Area | MTC applications |
|---|---|
| Security | Surveillance systems |
| | Backup for landline |
| | Control of physical access (e.g., to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/Control | Sensors |
| | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | ebook |

Applications, services, and solutions may be an Mobile Virtual Network Operator (MVNO) service, an emergency radio communication system, a Private Branch eXchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VoLTE) service, a charging service, a radio on demand service, a roaming service, an activity monitoring service, a telecom carrier/ communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and exemplary embodiments described in the present document. Needless to say, these technical ideas and example embodiments are not limited to the above-described UE and various modifications can be made thereto.

The above described CSI feedback occasion may be an aperiodic CSI feedback occasion.

The method performed by the access network node may further comprise determining if a PUSCH data transmission can be scheduled earlier than a PUCCH data transmission or if a PDSCH data transmission is to be scheduled; and transmitting the downlink DCI of Downlink DCI format to said terminal device if it is determined that a PUSCH data transmission cannot be scheduled earlier than a PUCCH data transmission or a PDSCH data transmission is to be scheduled.

The method performed by the access network node may further comprise, if a PUSCH data transmission can be scheduled earlier than a PUCCH data transmission or there is no PDSCH data to be scheduled, transmitting an uplink DCI of Uplink DCI format to said terminal device, wherein said uplink DCI is configured to trigger generation by the terminal device of CSI reporting data and to schedule a PUSCH data transmission to support transmission of said CSI reporting data. In this case, the uplink DCI may be configured to trigger generation by the terminal device of CSI reporting data.

The downlink DCI may comprise a PUCCH resource allocation field that acts to allocate PUCCH resources intended to support transmission by the terminal device of HARQ-ACK feedback data, and the method performed by the access network node may further comprise, if a PUSCH data transmission cannot be scheduled earlier than a PUCCH data transmission or a PDSCH data transmission is to be scheduled, determining if sufficient PUCCH resources are allocated by the PUCCH resource allocation field of the download DCI to support transmission of multiplexed CSI reporting data and HARQ-ACK feedback data and wherein said download DCI includes an indicator field to indicate to the terminal device whether to use the PUCCH resources allocated in the PUCCH resource allocation field for transmission of the CSI reporting data or to use PUSCH for transmission of the CSI reporting data. In this case, the PUSCH resource allocation may be preconfigured for the download DCI.

The download DCI format may include a PUSCH resource allocation field which, when populated, acts to allocate PUSCH resources intended to support transmission by the terminal device of CSI reporting data.

The indicator field may be configured to hold a first value to indicate, to the terminal device, that PUCCH data transmission is to be used to transmit the CSI reporting data, and a second value if PUSCH is to be used to transmit the CSI reporting data.

The above described access network node may further comprise means for determining if a PUSCH data transmission can be scheduled earlier than a PUCCH data transmission or if a PDSCH data transmission is to be scheduled; and transmit the downlink DCI of Downlink DCI format to said terminal device, if said determining means determines that a PUSCH data transmission cannot be scheduled earlier than a PUCCH data transmission or a PDSCH data transmission is to be scheduled.

The download DCI may include an indicator field to indicate to the terminal device whether to use the PUCCH resources allocated in the PUCCH resource allocation field for transmission of the CSI reporting data or to use PUSCH for transmission of the CSI reporting data. The download DCI may include a PUSCH resource allocation field and the access network node may be configured to allocate PUSCH resources in the PUSCH resource allocation field only for scheduling PUSCH data transmission only if the download DCI indicates that PUSCH data transmission is to be used to support transmission of said CSI reporting data.

The access network node may be preconfigured with a PUSCH resource allocation to be used only if the downlink DCI indicates that PUSCH data transmission is to be used to support transmission of said CSI reporting data.

Various other modifications will be apparent to those skilled in the art and will not be described in further detail here.

### Supplementary Note 1

A method performed by an access network node of a communications system comprising at least one terminal device configured to communicate with the access network node via a communications channel comprising a PDCCH, a PDSCH, a PUCCH and a PUSCH, the method comprising, for a CSI feedback occasion in respect of the terminal device:
transmitting a downlink DCI of Downlink DCI format to said terminal device, said downlink DCI being configured to trigger generation by the terminal device of CSI reporting data;
wherein said downlink DCI is further configured to schedule either a PUSCH or a PUCCH data transmission to support transmission of said CSI reporting data, depending on PUCCH availability when said CSI feedback occasion is determined.

### Supplementary Note 2

A method according to supplementary note 1, wherein said CSI feedback occasion is an aperiodic CSI feedback occasion.

### Supplementary Note 3

A method according to supplementary note 1 or supplementary note 2, further comprising determining if a PUSCH data transmission can be scheduled earlier than a PUCCH data transmission or if a PDSCH data transmission is to be scheduled; and transmitting the downlink DCI of Downlink DCI format to said terminal device if it is determined that a PUSCH data transmission cannot be scheduled earlier than a PUCCH data transmission or a PDSCH data transmission is to be scheduled.

### Supplementary Note 4

The method according to any of supplementary notes 1 to 3, further comprising, if a PUSCH data transmission can be scheduled earlier than a PUCCH data transmission or there is no PDSCH data to be scheduled, transmitting an uplink DCI of Uplink DCI format to said terminal device, wherein said uplink DCI is configured to trigger generation by the terminal device of CSI reporting data and to schedule a PUSCH data transmission to support transmission of said CSI reporting data.

### Supplementary Note 5

The method of supplementary note 4, wherein said uplink DCI is configured to trigger generation by the terminal device of CSI reporting data.

### Supplementary Note 6

The method according to any of supplementary notes 1 to 5, wherein the downlink DCI comprises a PUCCH resource allocation field that acts to allocate PUCCH resources intended to support transmission by the terminal device of HARQ-ACK feedback data, the method further comprising, if a PUSCH data transmission cannot be scheduled earlier than a PUCCH data transmission or a PDSCH data transmission is to be scheduled, determining if sufficient PUCCH resources are allocated by the PUCCH resource allocation field of the download DCI to support transmission of multiplexed CSI reporting data and HARQ-ACK feedback data and wherein said download DCI includes an indicator field to indicate to the terminal device whether to use the PUCCH resources allocated in the PUCCH resource allocation field for transmission of the CSI reporting data or to use PUSCH for transmission of the CSI reporting data.

### Supplementary Note 7

The method according to supplementary note 5, wherein a PUSCH resource allocation is preconfigured for the download DCI.

### Supplementary Note 8

The method according to supplementary note 5, wherein the download DCI format includes a PUSCH resource allocation field which, when populated, acts to allocate PUSCH resources intended to support transmission by the terminal device of CSI reporting data.

### Supplementary Note 9

The method according to any of any of supplementary notes 5 to 8, wherein said indicator field is configured to hold a first value to indicate, to the terminal device, that PUCCH data transmission is to be used to transmit the CSI reporting data, and a second value if PUSCH is to be used to transmit the CSI reporting data.

### Supplementary Note 10

An access network node of a communication system, the access network node being configured to communicate with a terminal device via a communications channel comprising a PDCCH, a PDSCH, a PUCCH and a PUSCH, and comprising:
means for triggering a CSI occasion in respect of a communicably coupled terminal device, configured to transmit a downlink DCI of Downlink DCI format to said terminal device, said downlink DCI being configured to trigger generation by the terminal device of CSI reporting data;
wherein said downlink DCI is further configured to schedule either a PUSCH or a PUCCH data transmission to support transmission of said CSI reporting data, depending on PUCCH availability when said CSI feedback occasion is determined.

### Supplementary Note 11

An access network node according to supplementary note 10, further comprising means for determining if a PUSCH data transmission can be scheduled earlier than a PUCCH data transmission or if a PDSCH data transmission is to be scheduled; and transmit the downlink DCI of Downlink DCI format to said terminal device, if said determining means determines that a PUSCH data transmission cannot be scheduled earlier than a PUCCH data transmission or a PDSCH data transmission is to be scheduled.

### Supplementary Note 12

An access network node according to supplementary note 10 or supplementary note 11, wherein said download DCI includes an indicator field to indicate to the terminal device whether to use the PUCCH resources allocated in the PUCCH resource allocation field for transmission of the CSI reporting data or to use PUSCH for transmission of the CSI reporting data.

### Supplementary Note 13

An access network node according to supplementary note 11, wherein the download DCI includes a PUSCH resource allocation field and the access network node is configured to allocate PUSCH resources in the PUSCH resource allocation field only for scheduling PUSCH data transmission only if the download DCI indicates that PUSCH data transmission is to be used to support transmission of said CSI reporting data.

### Supplementary Note 14

An access network node according to supplementary note 11, being preconfigured with a PUSCH resource allocation to be used only if the downlink DCI indicates that PUSCH data transmission is to be used to support transmission of said CSI reporting data.

### Supplementary Note 15

A method performed by a terminal device configured to communicate with an access network node of a communications system via a communications channel comprising a PDCCH, a PDSCH, a PUCCH and PUSCH, the method comprising:
receiving a downlink DCI of downlink DCI format, said downlink DCI being configured to trigger generation by the terminal device of CSI reporting data; wherein said downlink DCI is further configured to schedule either a PUSCH or a PUCCH data transmission to support transmission of said CSI reporting data; and
transmitting CSI reporting data to said access network node by means of a PUCCH or PUSCH data transmission, depending on a respective resource allocation in said received downlink DCI.

### Supplementary Note 16

A terminal device of a communications system comprising at least one access network node configured to communicate with said terminal device via a communications channel comprising a PDCCH, a PDSCH, a PUCCH and a PUSCH, the terminal device comprising:
means for receiving a downlink DCI of downlink DCI format, said downlink DCI being configured to trigger generation by the terminal device of CSI reporting data; wherein said downlink DCI is further configured to schedule either a PUSCH or a PUCCH data transmission to support transmission of said CSI reporting data; and
means for transmitting CSI reporting data to said access network node by means of a PUCCH or PUSCH data transmission, depending on a respective resource allocation in said received downlink DCI.

### Supplementary Note 17

A communication system comprising a core network device, an access network node according to any of claims 10 to 14 and at least one terminal device configured to communicate therewith via a communications channel comprising a PDCCH, a PDSCH, a PUCCH and a PUSCH.

### Supplementary Note 18

A communication system comprising a core network device, an access network node, and a terminal device according to supplementary note 16 configured to communicate therewith via a communications channel comprising a PDCCH, a PDSCH, a PUCCH and a PUSCH.

### Supplementary Note 19

A computer implementable instructions product comprising computer implementable instructions for causing a programmable communications device to perform the method according to any of supplementary notes 1 to 9.

### Supplementary Note 20

A computer implementable instructions product comprising computer implementable instructions for causing a programmable communications device to perform the method according to supplementary note 15.

This application is based upon and claims the benefit of priority from United Kingdom Patent Application No. 2012333.7, filed on Aug. 7, 2020, the disclosure of which is incorporated herein in its entirety by reference.

What is claimed is:

1] A method performed by an access network node of a communication system, the method comprising
for a Channel State Information (CSI) feedback occasion in respect of a terminal device, transmitting a downlink Downlink Control Information (DCI) of a Downlink DCI format to the terminal device, the downlink DCI being configured to trigger generation by the terminal device of CSI reporting data,
wherein the downlink DCI is further configured to schedule either a Physical Uplink Shared Channel (PUSCH) data transmission or a Physical Uplink Control Channel (PUCCH) data transmission, depending on PUCCH availability.

2] The method according to claim 1, wherein the CSI feedback occasion is an aperiodic CSI feedback occasion.

3] The method according to claim 1, further comprising:
determining if the PUSCH data transmission can be scheduled earlier than a the PUCCH data transmission or if a Physical Downlink Shared Channel (PDSCH) data transmission is to be scheduled, wherein
the transmitting is performed if it is determined that the PUSCH data transmission cannot be scheduled earlier than the PUCCH data transmission or the PDSCH data transmission is to be scheduled.

4] The method according to claim 1, further comprising, if the PUSCH data transmission can be scheduled earlier than the PUCCH data transmission or there is no PDSCH data to be scheduled, transmitting an uplink DCI of a Uplink DCI format to the terminal device, wherein
the uplink DCI is configured to trigger generation by the terminal device of the CSI reporting data and to schedule the PUSCH data transmission.

5] (canceled)

6] The method according to claim 1, wherein
the downlink DCI includes a PUCCH resource allocation field for allocating a PUCCH resource for transmission by the terminal device of Hybrid Automatic Repeat Request -Acknowledgement (HARQ-ACK) feedback data, and the method further comprising:
if the PUSCH data transmission cannot be scheduled earlier than the PUCCH data transmission or a PDSCH data transmission is to be scheduled, determining if a PUCCH resource is allocated by the PUCCH resource allocation field of the downlink DCI for transmission of multiplexed CSI reporting data and HARQ-ACK feedback data, and wherein
the downlink DCI includes an indicator field to indicate to the terminal device whether to use the PUCCH resource or a PUSCH resource.

7] The method according to claim 6, wherein a PUSCH resource allocation is preconfigured for the downlink DCI.

8] The method according to claim 6, wherein the downlink DCI format includes a PUSCH resource allocation field which, when populated, acts to allocate a PUSCH resource for transmission by the terminal device of the CSI reporting data.

9] The method according to claim 6, wherein the indicator field is configured to hold a first value to indicate, to the terminal device, that the PUCCH data transmission is to be used to transmit the CSI reporting data, and a second value if the PUSCH resource is to be used to transmit the CSI reporting data.

10] An access network node of a communication system, the access network node comprising:
a controller; and
a transceiver, wherein the controller is configured to control the transceiver to:
transmit a downlink Downlink Control Information (DCI) of a Downlink DCI format to a terminal device in order to trigger a Channel State Information (CSI) occasion in respect of the terminal device, configured to, the downlink DCI being configured to trigger generation by the terminal device of CSI reporting data;
wherein the downlink DCI is further configured to schedule either a Physical Uplink Chared Channel (PUSCH) data transmission or a Physical Uplink Control Channel (PUCCH) data transmission to support transmission of said-the CSI reporting data, depending on PUCCH availability when said CSI feedback occasion is determined availability.

11] The access network node according to claim 10, wherein the controller is further configured to:
determine if the PUSCH data transmission can be scheduled earlier than the PUCCH data transmission or if a Physical Downlink Shared Channel (PDSCH) data transmission is to be scheduled; and
control the transceiver to transmit the downlink DCI of the Downlink DCI format to the terminal device, if it is determined that the PUSCH data transmission cannot be scheduled earlier than the PUCCH data transmission or the Physical Downlink Shared Channel (PDSCH) data transmission is to be scheduled.

12] The access network node according to claim 10, wherein
the downlink DCI includes a PUCCH resource allocation field for allocating a PUCCH resource for transmission by the terminal device of Hybrid Automatic Repeat Request - Acknowledgement (HARQ-ACK) feedback data, and the controller is configured to:
if the PUSCH data transmission cannot be scheduled earlier than the PUCCH data transmission or a PDSCH data transmission is to be scheduled, determine if a PUCCH resource is allocated by the PUCCH resource allocation field of the downlink DCI for transmission of multiplexed CSI reporting data and HARQ-ACK feedback data, and wherein
the downlink DCI includes an indicator field to indicate to the terminal device whether to use the PUCCH resource or a PUSCH resource.

13] The access network node according to claim 11, wherein
the downlink DCI includes a PUSCH resource allocation field, and
the controller is configured to allocate a PUSCH resource in the PUSCH resource allocation field for scheduling the PUSCH data transmission if the downlink DCI indicates that the PUSCH data transmission is to be used to support transmission of the CSI reporting data.

14] The access network node according to claim 11, wherein a PUSCH resource allocation is preconfigured for the downlink DCI.

15] A method performed by a terminal device configured to communicate with an access network node of a communication system, the method comprising:
receiving a downlink Downlink Control Information (DCI) of downlink DCI format, the downlink DCI being configured to trigger generation by the terminal device of Channel State Information (CSI) reporting data; wherein the downlink DCI is further configured to schedule either a Physical Uplink Shared Channel (PUSCH) data transmission or a PUCCH Physical Uplink Control Channel (PUCCH) data transmission to support transmission of the CSI reporting data; and
transmitting the CSI reporting data to the access network node by means of a the PUCCH data transmission or the PUSCH data transmission, depending on a resource allocation in the downlink DCI.

16] A terminal device configured to communicate with an access network node of a communication system, the terminal device comprising:
a controller; and
a transceiver, wherein the controller is configured to:
control the transceiver to receive a downlink Downlink Control Information (DCI) of a downlink DCI format, the downlink DCI being configured to trigger generation by the terminal device of Channel State Information (CSI) reporting data; wherein the downlink DCI is further configured to schedule either a Physical Uplink Shared Channel (PUSCH) data transmission or a Physical Uplink Control Channel (PUCCH) data transmission to support transmission of said-the CSI reporting data; and
control the transceiver to transmit the CSI reporting data to the access network node by means of the PUCCH data transmission or the PUSCH data transmission, depending on a resource allocation in the downlink DCI.

17-20] (canceled)
